(19) United States
(12) Patent Application Publication
(10) Pub. No.: US 2022/0406555 A1
(43) Pub. Date: Dec. 22, 2022

(54) CONSTANT DISCHARGE CURRENT BLEEDER

(71) Applicant: KONINKLIJKE PHILIPS N.V., EINDHOVEN (NL)

(72) Inventors: ROLF KARL OTTO BEHLING, NORDERSTEDT (DE); ROLAND PROKSA, NEW WULMSTORF (DE); BERNHARD GLEICH, HAMBURG (DE); BERND RUDI DAVID, GRÜNBERG (DE); CLAAS BONTUS, HAMBURG (DE); TOBIAS REUSCH, HAMBURG (DE); AXEL THRAN, HAMBURG (DE)

(21) Appl. No.: 17/776,407

(22) PCT Filed: Nov. 6, 2020
(86) PCT No.: PCT/EP2020/081219

§ 371 Date: May 12, 2022

(30) Foreign Application Priority Data
Nov. 14, 2019 (EP) 19209027.2

(51) Int. Cl. H01J 35/04; H01J 35/10; H01J 35/06; H05G 1/08; H05G 1/70

(52) U.S. Cl. CPC H01J 35/045; H01J 35/10; H01J 35/066; H01J 35/065; H05G 1/085; H05G 1/70; H01J 2235/068

(57) ABSTRACT

The present invention relates to a rotary anode X-ray source. In addition to a primary cathode of a rotary anode X-ray tube, an auxiliary cathode is provided in the rotary anode X-ray tube. Electrons from the auxiliary cathode are focused into an area on the anode, from which X-rays cannot enter the used X-ray beam generated by the primary cathode. An emission current controlling device is used to control the electron emission of the auxiliary cathode. Thus, the voltage down-ramp for dual energy scanning is kept constant even though the primary X-ray output changes for the sake of dose modulation or during a transient of the primary electron current.

### FIELD OF THE INVENTION

The present invention relates to an X-ray tube, an X-ray imaging system, and a method of X-ray tube control.

### BACKGROUND OF THE INVENTION

A rotary anode X-ray source is a standard device for generating a beam of X-ray useful, for example, in medical X-ray equipment such as computed tomography (CT) scanners, and C-arm imaging systems. In a rotary anode X-ray source, a cathode and an anode are arranged to face each other in a vacuum envelop at such a distance such that thermionic electron emission occurs between the cathode and the anode, when a suitable potential difference is generated between them. Electrons are accelerated from the cathode through an electric field to the anode. When the electrons collide at a high speed with the anode, energy is dissipated in the form of heat, and X-ray radiation. In fact, over ninety-nine percent of the energy is dissipated as heat, which has necessitated the use of a rotating anode to reduce the thermal damage to the anode in high-power applications. The small proportion of energy emitted from the anode as X-ray radiation is directed towards an X-ray window of the X-ray source for clinical use.

Sending X-rays of different spectra allows imaging the object of interest with spectral material decomposition. For example, the higher differential attenuation of bones as a function of energy compared to soft tissue allows the ability to decompose two images taken at different x-ray energies into tissue-selective representation of the anatomy, namely “soft-tissue only” and “bone-only” images. This technique has proven to yield better diagnostics, and save toxic contrast dyes. In case of dual energy scanning, the tube voltage may be rapidly switched between a low (for example 70 kV) and high (for example 140 kV) value during each rotation. Thus, smoothing capacitance in the generator and cables have to be charged and discharged at a fast pace. However, because of the significant tube ramp up and down between the high and low tube voltages, the use of independent filtration and tube current modulation may be not possible.

US 2010/002829 A1 relates to an apparatus for CT cone beam scanning comprising a plurality of radiation cone beam sources spaced in a direction parallel to the rotation axis.

### SUMMARY OF THE INVENTION

There may be a need to have an improved rotary anode X-ray source. The object of the present invention is solved by the subject-matter of the independent claims, wherein further embodiments are incorporated in the dependent claims.

Towards this end, a first aspect of the present invention provides an X-ray tube for generating an X-ray beam that comprises: a primary cathode, an auxiliary cathode, a rotatable anode, and an electron current controlling device. The primary cathode is arranged and configured to emit first electrons establishing a flow of primary electron current, the first electrons being focused on a first area on the rotatable anode for generating the X-ray beam. The auxiliary cathode is arranged and configured to emit second electrons establishing a flow of auxiliary electron current, the second electrons being directed to a second area, which is different from the first area, on the rotatable anode for generating X-rays. The generated X-rays are configured to be directed to a direction different from that of the X-ray beam such that the X-rays do not enter the X-ray beam. The electron current controlling device is configured to adjust the auxiliary electron current in response to a change of the primary electron current such that a sum of the primary electron current and the auxiliary electron current remains constant.

Accordingly, in addition to a primary cathode of a rotary anode X-ray tube, an auxiliary cathode is provided in the rotary anode X-ray tube. The auxiliary X-ray source, though inevitably creating X-rays, is only a beam dump. Its radiation does not enter the used beam. Both cathodes may share the same heating current when connected in series, or the same heating voltage when connected in parallel. This may reduce the number of feed-throughs. Electrons from the auxiliary cathode are focused into an area on the anode, from which X-rays cannot enter the used X-ray beam generated by the primary cathode. For example, the anode may be shaped to provide a first tilted surface for directing the X-rays generated by the primary cathode to one direction and to provide a second tilted surface for directing the X-rays generated by the auxiliary cathode to another different direction. An emission current controlling device, such as an emission control grid arranged between the auxiliary cathode and the anode, and/or at least one heating supply configured to supply the primary and/or the auxiliary cathodes, is used to control the electron emission of the auxiliary cathode. For example, the emission control grid may be charged such that the sum of the electron emission from both cathodes is kept constant during operation no matter what electron emission the primary cathode emits. In another example, the at least one heating supply may be configured to supply the primary and the auxiliary cathodes with different heating powers such that the sum of the primary electron current and the auxiliary electron current remains constant during a CT scan or other multi-energy X-ray exposure. Thus, slope and duration of down-ramp of the high voltage for dual energy scanning are kept constant even though the primary X-ray output changes for the sake of dose modulation or during a transient of the primary electron current. Independent filtration and tube current modulation may thus be applied using the X-ray tube. This will be explained hereafter and particularly with respect to the exemplary embodiments in FIGS. 3 and 4.

According to an embodiment of the present invention, the electron current controlling device comprises an emission control grid arranged between the auxiliary cathode and the anode. The emission control grid is configured to control the flow of the auxiliary electron current between the auxiliary cathode and the anode.

The emission control grid, also referred to as control grid, is an electrode used to control the flow of electrons from the cathode to the anode electrode. It may comprise a grating structure or simply consist of isolated electrodes, which may be charged positively or, typically, negatively, with respect to the electron emitter. The heated emitter emits negatively charged electrons, which are attracted to and captured by the anode, which is given a positive voltage by a power supply. The control grid between the cathode and anode functions as a “gate” to control the current of electrons reaching the anode. A less negative, or positive, voltage on the grid will allow more electrons through, increasing the anode current. A given change in grid voltage causes a proportional change in plate current, so if a time-varying voltage is applied to the grid, the plate current waveform will reflect the applied grid voltage. A relatively small variation in voltage on the emission control grid may cause a significantly large variation in anode current. As the emission control grid may be charged and discharged on a time scale of a few microseconds, the emission control grid may allow a fast response to a change of the primary electron current. This will be explained hereafter and particularly with respect to the exemplary embodiment in FIG. 3.

According to an embodiment of the present invention, the emission control grid has a grid control voltage that is configured to sufficiently reduce the auxiliary electron current such that the X-ray beam is generated with a maximum X-ray intensity.

In other words, the grid control voltage may allow to totally, or at least to a large extent, blank the auxiliary electron current for the case that the tube has to produce the maximum of used X-ray intensity. As the cathode does not need to produce fine focal spots from the auxiliary electron beam, the filament of the auxiliary cathode may be long and narrow. In this way, the cut-off grid voltage may be minimized.

According to an embodiment of the present invention, the electron current controlling device comprises at least one heating supply configured to supply the primary and the auxiliary cathodes with different heating powers such that the sum of the primary electron current and the auxiliary electron current remains constant.

In a hot cathode, the cathode surface may be induced to emit electrons by heating it with a filament, a thin wire of refractory metal like tungsten with current flowing through it. The wire may have a diameter of 100 μm up to 300 μm preferably 250 μm. It may alternatively comprise a flat sheet of metal, preferably from tungsten, of a thickness of between 50 μm and 500 μm, preferably 200 mm. The emitter inside the cathode is heated to a sufficiently high temperature that causes electrons to be ejected from its surface into the evacuated space in the tube, a process called thermionic emission, which basically follows the Richardson-Dushman law when space charge effects can be ignored. Space charge may become important when the tube voltage is low, e.g. below 80 kV for a tube for computed tomagraphy, and/or the grid voltage is negative, typically a few hundred volts. The at least one heating supply may comprise an alternating current (AC) heating circuit with a variable frequency and controllable voltage amplitude. Alternatively, the at least one heating supply may comprise a primary heating supply associated with the primary cathode and an auxiliary heating supply associated with the auxiliary cathode. This will be explained hereafter and particularly with respect to the exemplary embodiment in FIG. 4.

According to an embodiment of the present invention, the at least one heating supply comprises an alternating current (AC) heating circuit with a variable frequency and controllable voltage amplitude. The AC heating circuit is configured to supply the primary and the auxiliary cathodes with different heating powers using at least one of an inductor and a capacitor.

When an AC heating circuit, equipped with inductors and/or capacitors and applying a variable frequency, is used, a suitable distribution of the total tube current between primary and auxiliary cathode takes place in the tube.

According to an embodiment of the present invention, the at least one heating supply comprises a primary heating supply associated with the primary cathode and an auxiliary heating supply associated with the auxiliary cathode. The auxiliary heating supply is configured to change a heating current of the auxiliary cathode to adjust the auxiliary electron current in response to a change of the primary electron current such that a sum of the primary electron current and the auxiliary electron current remains constant during X-ray exposure with dual X-ray energy.

In other words, temperature change of the primary cathode will change the intensity of the used X-ray beam. The temperature of the auxiliary cathode may be steered such that the sum of the electron current from both cathodes is kept constant even if the emission of the primary cathode changes and during transients of the primary electron current. Thus, the slope of the high-voltage down-ramp of the tube voltage for dual energy scanning is kept constant even though the X-ray output of the tube changes for dose modulation.

According to an embodiment of the present invention, the primary cathode and the auxiliary cathode are connected in series or in parallel.

According to an embodiment of the present invention, when connected in series with the primary cathode, the auxiliary cathode is configured to produce a sufficiently high auxiliary electron current at a lower heating power compared with a heating power required for the primary cathode to keep the sum of the primary electron current and the auxiliary electron current constant for the case that the primary cathode carries only a minimal primary electron current close to zero.

It is the power supplied to the auxiliary cathode to generate electron emission. “Lower heating power” means smaller heating power to be supplied to the auxiliary cathode for a given auxiliary electron emission current compared with the heating power required for the primary emitter for the same electron current. This should hold notably for the power supplied to the auxiliary electron emitter at minimal electron current settings (low emitter temperatures). For these settings the temperatures of the emitters (primary cathode, emitting the primary current, and auxiliary cathode) are close to the temperature where only a small (e.g. close to zero) electron emission of the primary cathode is generated. This means in practice that the electron emissive surface area of the electron emitter of the auxiliary cathode should be large compared with that of the primary cathode. In this case, even at the same heating current for both emitters (when both cathodes are connected in series and carry the same heating current), the auxiliary cathode emits more electrons than the primary cathode. In other words, its “low heating power” is sufficient to generate “sufficiently high” electron current.

In other words, when connected in series with the primary cathode, the auxiliary cathode may be powerful enough to produce a high electron current even at low heating current, e.g., when dose modulation with the primary cathode is on, to deliver the full tube current, e.g. at minimal absolute grid voltage, for the case that the primary cathode carries only a minimal current close to zero. To achieve this, the auxiliary emitter may be relatively large. This may be possible, as the resulting X-ray focal spot may be large as well.

According to an embodiment of the present invention, the auxiliary cathode is configured to have a slew rate for rise and/or fall of the auxiliary electron current upon a change of the heating current, which is configured to be equal or higher than that of the primary cathode.

Another option may be the use of an auxiliary electron emitter with a shorter time constant during heating and cooling compared with the primary emitter. This is equivalent to a higher slew rate, i.e. steeper rise and fall of the electron emission. This could be realized by using a lower mass. The auxiliary emitter may be made of comparatively thin sheet of metal compared with the primary emitter. In such a configuration the auxiliary emitter cools faster, as it has a lower thermal capacity whereas both emitters have about the same heat radiating surface area and albedo. Another option would be using thicker wire connectors with larger heat conduction for the auxiliary emitter. In this configuration, too, is the time for cooling shorter. The slew rate for heating can be controlled by boosting the heating current. Cooling is a thermo-mechanical characteristic of the emitter configuration. The heating current during the cooling time is zero; cooling may happen in a “passive” way.

As the tube voltage changes, the heating curve of the primary tube may be different from the heating curve of the auxiliary cathode. The slew rate of emission current of the auxiliary cathode upon sudden change of the heating current may be higher at least for falling current than that of the primary cathode. This may be achieved through higher heat conduction from the wire to the surrounding cathode structure with the aid of a thicker emitter holder. The slew rate may be higher even at low emission current. This will allow the auxiliary electron beam to be controllable quickly enough. Typically, the relative slew rate, defined as rate of change of tube current per time, rises with temperature and, thus, emission current, as heat radiation takes a major share of the total heat dissipation of the electron emitter, as discussed below. Therefore, the primary emitter, when operated at high current, tends to show a fast slew rate. The auxiliary emitter may be constructed in such a way that its temporal response is fast enough even at moderate temperature and low emitted auxiliary current.

According to an embodiment of the present invention, the auxiliary cathode is configured to have a higher heat conduction from a wire of the auxiliary cathode to a surrounding than that of the primary cathode. Alternatively or additionally, the auxiliary cathode is configured to have a higher heat radiation from a wire of the auxiliary cathode to a surrounding than that of the primary cathode.

Heat conduction is the conductive heat transfer, in metals dominated by electrons in the conduction band. The amount of power dissipated is proportional to the temperature difference between hot and cold member. For example, the auxiliary cathode may be arranged on a thicker emitter holder such that the auxiliary cathode cools much faster than the primary cathode.

Heat radiation or thermal radiation is active even without direct connection of material, through electromagnetic (heat) radiation. Its power is proportional to the fourth power of absolute temperature of the radiating body, minus the fourth power of the ambient temperature. For example, the auxiliary cathode may have a thinner emitter wire such that it cools much faster than the primary cathode.

According to an embodiment of the present invention, the X-ray tube comprises a further emission control grid arranged between the primary cathode and the anode. The further emission control grid is configured to control a shape of the first electrons to adjust a focal spot on the first area on the rotatable anode.

With multiple grids (multiple outputs of the grid supply unit), the primary cathode may be switched with a second, digital or analogue, output. A second analogue output may also be foreseen which may control the electron emission from the primary cathode. It has to be made sure, however, that the focal spot on the anode is never overheated during such analogue current control. The emission from the auxiliary cathode has then to be controlled in such a way that the sum of both currents is kept constant.

According to an embodiment of the present invention, the further emission control grid arranged between the primary cathode and the anode is configured as a focusing electrode or a set of focusing electrodes to keep a size of the focal spot constant when the tube voltage changes.

In other words, the primary cathode may comprise an emission control grid that may be configured as a focusing electrode or a set of focusing electrodes, e.g. a pair, in addition to its function as a current control grid, to keep the size of the focal spot constant when the tube voltage changes. This may be used to avoid image artifacts or poor spectral performance of the X-ray system. The grid control voltage, which controls the size of the focal spot, would be adapted accordingly. In addition, the auxiliary cathode may be equipped with a similar emission control grid. The grid control voltage of the auxiliary control grid would be adapted in sync with the changing primary control voltage to keep the total tube current constant even though the primary electron current would change with the changing tube voltage, the changing grid control voltage for focusing as well as with the changing heating current of the primary cathode. The total tube current, the sum of primary and auxiliary current, may also be controlled in a different way, other than keeping the total current constant.

In an example, the primary cathode comprises at least one of a field emission cathode, a photo cathode, and an indirectly heated cathode.

According to an embodiment of the present invention, the auxiliary cathode comprises a field emission cathode.

Field emission cathodes may serve particularly well as auxiliary cathode. Compared with thermionic tungsten emitters, their maximum permitted macroscopic emission current density may be typically smaller. But, as the focal spot of the auxiliary electron beam can be large, this deficit is of minor relevance. The emitting surface may simply be rather large. One of the benefits of field emitting structures is their fast response of the emitted electron current to changes of the grid voltage. Thus, they may require a grid to control the emission right. Both, the primary and the auxiliary cathode, or only one of them, may be field emitting.

According to a second aspect of the present invention, an X-ray imaging system is provided that comprises an X-ray tube as described above and below and an X-ray detector arranged to be opposite to the X-ray tube. The X-ray tube is configured to generate an X-ray beam towards an object of interest. The X-ray detector is configured to detect attenuated X-rays passing through the object of interest.

Accordingly, the down-ramp of the tube voltage for dual energy scanning is kept constant even though the X-ray output of the tube changes for dose modulation. This will be explained hereafter and particularly with respect to the exemplary embodiment illustrated in FIG. 5.

According to a third aspect of the present invention, a method of X-ray tube control is provided that comprises:
emitting, by a primary cathode of an X-ray tube as described above and below, first electrons establishing a flow of primary electron current, the first electrons being focused on a first area on a rotatable anode of the X-ray tube for generating an X-ray beam;
emitting, by an auxiliary cathode of the X-ray tube, second electrons establishing a flow of auxiliary electron current, the second electrons being directed to a second area, which is different from the first area, on the rotatable anode for generating X-rays, wherein the generated X-rays are configured to be directed to a direction different from that of the X-ray beam such that the X-rays do not enter the X-ray beam; and
adjusting, by an electron current controlling device of the X-ray tube, the auxiliary electron current in response to a change of the primary electron current such that a sum of the primary electron current and the auxiliary electron current remains constant during a CT scan or other multi-energy X-ray exposure.

This will be explained hereafter and particularly with respect to the exemplary embodiment illustrated in FIG. 6.

In an example, the primary cathode and the auxiliary cathode may be connected in series or in parallel.

In an example, the electron current controlling device may comprise an emission control grid arranged between the auxiliary cathode and the anode. The emission control grid may be configured to control the flow of the auxiliary electron current between the auxiliary cathode and the anode.

In an example, the emission control grid may have a grid control voltage that is configured to sufficiently reduce the auxiliary electron current, e.g. by switching off the heating current and/or steering the control electrode to a more negative bias, such that the X-ray beam is generated with a maximum X-ray intensity.

In an example, when connected in series with the primary cathode, the auxiliary cathode may be configured to produce a sufficiently high auxiliary electron current at a low heating power to keep the sum of the primary electron current and the auxiliary electron current constant for the case that the primary cathode carries only a minimal primary electron current close to zero.

In an example, the electron current controlling device may comprise at least one heating supply configured to supply the primary and the auxiliary cathodes with different heating powers such that the sum of the primary electron current and the auxiliary electron current remains constant.

In an example, the at least one heating supply may comprise an alternating current (AC) heating circuit with a variable frequency. The AC heating circuit is configured to supply the primary and the auxiliary cathodes with different heating powers using at least one of an inductor and a capacitor.

In an example, the at least one heating supply may comprise a primary heating supply associated with the primary cathode and an auxiliary heating supply associated with the auxiliary cathode. The auxiliary heating supply is configured to change a heating current of the auxiliary cathode to adjust the auxiliary electron current in response to a change of the primary electron current such that a sum of the primary electron current and the auxiliary electron current remains constant.

In an example, the auxiliary cathode may have a slew rate for rise and/or fall of the auxiliary electron current upon a change of the heating current, which is configured to be equal or higher than that of the primary cathode.

In an example, the auxiliary cathode may be configured to have a higher heat conduction from a wire of the auxiliary cathode to a surrounding than that of the primary cathode. Alternatively or additionally, the auxiliary cathode may be configured to have a higher heat radiation from a wire or other emitting member of the auxiliary cathode to a surrounding than that of the primary cathode.

In an example, the X-ray tube may comprise a further emission control grid arranged between the primary cathode and the anode. The further emission control grid is configured to control a shape of the first electron beam to adjust an X-ray focal spot on the first area on the rotatable anode.

In an example, the primary cathode may comprise at least one of a field emission cathode, a photo cathode, and an indirectly heated cathode.

In an example, the auxiliary cathode may comprise a field emission cathode.

According to another aspect of the present invention, a computer program element is provided, which, when being executed by at least one processing unit, is adapted to cause the processing unit to perform the method as described above and below.

According to a further aspect of the present invention, a computer readable medium is provided comprising the computer program element.

As used herein, the term “X-ray tube” means a vacuum envelope in which X-ray emission from a rotating anode can occur. Typically, the X-ray tube includes a rotating anode, and a cathode arranged to emit electrons towards the rotating anode. The rotating anode is supported on a rotatable anode member attached to a rotor element which may be a part of the rotatable anode member drive.

As used herein, the term “cathode” may also be referred to as thermionic electron emitter, or simply electron emitter, which is part of an X-ray tube and serves to expel the electrons from the circuit and focus them in a beam on the focal spot of the anode. It is a controlled source of electrons for the generation of X-ray beams. The electrons are produced by heating the filament, i.e. a coil of wire made from e.g. tungsten, placed within a cup shaped structure, a highly polished nickel focusing cup, providing electrostatic focusing of the beam on the anode. In order to expel the electrons from the system, they need to be given sufficient kinetic energy. Heat generated by a heating supply is used to expel the electrons from the cathode. The process is called thermionic emission. The filament is heated with the electric current passing through it and the electrons are then expelled from the cathode.

As used herein, the term “primary cathode”, also referred to as primary emitter, refers to a cathode configured to emit electrons, which are focused on an area on the anode for generating an X-ray beam. The X-ray beam may then be collimated and sent to an object of interest.

As used herein, the term “auxiliary cathode”, also referred to as auxiliary emitter, refers to a cathode configured to emit electrons, which are focused on another area on the anode for generating X-rays, which are not used, i.e. not applied to an object of interest.

As used herein, the term “electron current controlling device” refers to a device capable of adjusting the auxiliary electron current in response to a change of the primary electron current. In an example, the electron current controlling device may comprise an emission control grid arranged between the auxiliary cathode and the anode, which functions as a “gate” to control the current electrons reaching the anode. In another example, the electron current controlling device may be one or more heating devices configured to heat the primary and auxiliary cathodes differently. The electron current controlling device may be a computer-implemented or firmware processing controlling device configured to receive the value of the primary electron current during dual energy scanning, and to use the primary electron current as a feedback to calculate, e.g. the value of the negative voltage on the emission control grid and/or the value of the heating current of the auxiliary cathode, to adjust the auxiliary electron current such that the sum of the sum of the electron emission from both cathodes is always kept constant independent of the emission the primary cathode during CT dose modulation.

As used herein, the term “constant” may also be understood as “sufficiently constant”. In other words, the term “constant” refers to the complete or nearly complete extent or degree of a constant state as indicated. The exact allowable degree of deviation from absolute completeness may depend on the accuracy of the control. For example, the exact allowable degree of deviation from the state of being constant may depend on the accuracy of controlling the grid voltage or the heating current.

The term “X-ray imaging system” may refer to an X-ray imaging system used, for example, in medical radiography, in airport security scanners, in industry (e.g. industrial radiography and industrial CT scanning), or research (e.g. small animal CT).

The term “object of interest” may include e.g., human bodies, animals, manufactured components, etc.

These and other aspects of the present invention will become apparent from and be elucidated with reference to the embodiments described hereinafter.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 illustrates a schematic central cut-through view of a conventional rotary anode X-ray tube assembly.

FIG. 2 illustrates the tube ramp down between the high and low tube voltages during discharging from 140 kV down to 80 kV of a conventional X-ray tube.

FIG. 3 shows a schematic central cut-through view of a rotary anode X-ray tube 12 according to some embodiments of the present disclosure.

FIG. 4 shows a schematic central cut-through view of a rotary anode X-ray tube 12 according to some further embodiments of the present disclosure.

FIG. 5 shows an X-ray system according to some embodiments of the present disclosure.

FIG. 6 shows a flow diagram of a method of X-ray tube control according to some embodiments of the present disclosure.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

In a CT or C-arm X-ray system, a rotatory anode X-ray tube rotates about a region of interest configured to accommodate an object of interest. The rotatory anode X-ray tube generates a beam of X-rays. Opposite to the rotary anode X-ray tube, held on a gantry rotor assembly of a CT scanner or a C-arm assembly, is a detector subsystem which converts attenuated X-rays into electrical signals.

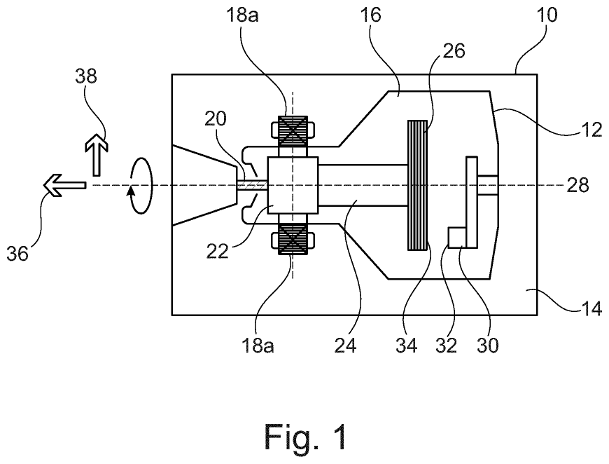

FIG. 1 illustrates a schematic central cut-through view of a conventional rotary anode X-ray tube assembly. Housing 10 provides a mounting point mounting point for the X-ray source assembly, and typically holds an insulating oil 14 used to provide more effective thermal management by conducting heat away from a rotary anode X-ray tube in operation. A rotary anode X-ray tube 12 is arranged inside the housing 10. The rotary anode X-ray tube 12 is typically formed from glass, and encloses a vacuum 16.

A stator 18a would be mounted to the housing and typically entirely encompasses X-ray tube 12. The stator is denoted in FIG. 1 as portions 18a and 18b, but these are section views of the same, unitary circular stator. In FIG. 1, a single circular stator 18a is shown in cross-section. An anode support shaft 20 supports a rotor body 22, a bearing system 24, and a rotatable anode disk 26. Rotor body 22, bearing system 24 and anode disk 26 are all arranged to be rotatable around the anode support shaft 20 (aligned with the centre axis 28) inside the rotary X-ray tube 12. Rotor body 22 is, typically, made from copper. The stator 18a and rotor body 22 are arranged in a facing relationship such that when a driving current is applied to stator 18a a magnetic field induces a current in rotor body 22. The current circulating in the rotor body 22 itself opposes the stator magnetic field causing the rotor to exert a rotational force on the bearing system, thus rotating the anode disk 26. Typically, anode disk 26 rotates between fifty and two hundred revolutions per second.

The bearing system 24 typically comprises a spiral groove bearing (hydrodynamic bearing) having a thrust bearing portion and a radial bearing portion. This ensures a relatively low maintenance and temperature resistant support of the rotational components of the X-ray tube. The bearing system is typically lubricated with a liquid metal lubricant to enable an electrical connection between the anode disk and the outside of the X-ray tube envelope.

A cathode 30 is provided at the opposite end of the tube to the rotor, and comprises an electrode 32 configured, when energized with a high negative voltage relative to the voltage of the rotary anode, to emit electrons across the gap between the cathode and the anode disk 26. The cathode 30 typically comprises a wire filament or a flat emitter that emits electrons when heated. The temperature of the emitter is controlled by the tube current control of the machine. As the tube current is increased, the temperature of the filament is increased and the filament produces more electrons. The number of electrons available and the time period set for their release from the filament determines the amount of x-rays produced from the anode. Given a tube voltage, the tube-current-time-product thus controls the total number of x-ray photons produced. Electrons are accelerated between electron emitter inside the cathode 30 and the focal spot 34 on the anode disk 26. Upon colliding with the anode disk, the energy of the emitted electrons is substantially converted to heat, which must be dissipated from the anode disk 26, partly through the bearing system and partly by heat radiation into the insulating oil 14. Less than one percent of the electron energy is converted into X-rays emitted from the focal spot 34 on the anode disk 26 outside of the X-ray tube. The X-rays emitted from the focal spot 34 may then be collimated and applied to an object of interest.

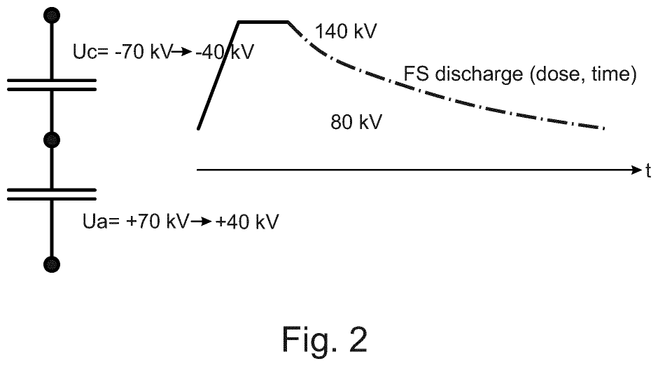

The rotary anode X-ray tube 12 described in FIG. 1 may send X-rays of different spectra allowing imaging the object of interest with spectral material decomposition. This technique has proven to yield better diagnostics, and save toxic contrast agent. The tube voltage may be rapidly switched between a low (for example 70 kV) and high (for example 140 kV) value during a CT scan. Thus, smoothing capacitance in the generator and cables have to be charged and discharged at a fast pace. However, because of the significant ramp up and down between the high and low tube voltages, tube current modulation may become difficult, as the slope of the down ramp may depend on the (modulated) tube current. This uncertainty of the applied X-ray spectra may impair the material decomposition during image reconstruction. As an example, FIG. 2 illustrates the tube ramp down between the high and low tube voltages during discharging from 140 kV down to 80 kV of a conventional X-ray tube. The discharge pattern will depend on the tube current and, thus, on the emitter temperature.

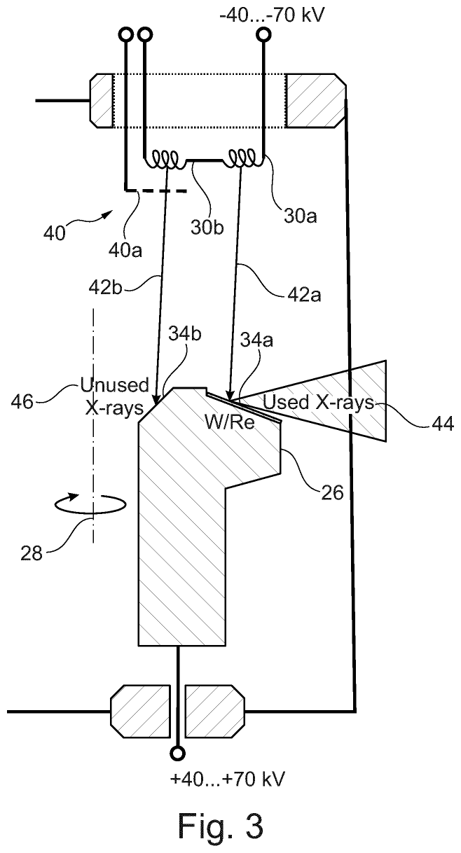

FIG. 3 shows a schematic central cut-through view of a rotary anode X-ray tube 12 according to some embodiments of the present disclosure. The rotary anode X-ray tube 12 comprises a primary cathode 30a, an auxiliary cathode 30b, a rotatable anode 26, and an electron current controlling device 40. In other words, in addition to the primary cathode 30a, an auxiliary cathode 30b is provided.

The primary cathode 30a is arranged and configured to emit first electrons establishing a flow of primary electron current 42a. Examples of the primary cathode 30a may include, but not limited to, a field emission cathode, a photo cathode, and an indirectly heated cathode. The first electrons are focused on a first area 34a on the rotatable anode for generating an X-ray beam 44. Typically, less than one percent of the electron energy is converted into X-rays emitted from the focal spot 34a on the rotatable anode 26 outside of the X-ray tube. The X-ray beam 44 emitted from the focal spot 34a may then be collimated and applied to an object of interest. The X-ray beam 44 may also be referred to as used X-rays.

The auxiliary cathode 30b is arranged and configured to emit second electrons establishing a flow of auxiliary electron current 42b. Examples of the auxiliary cathode 30b may include, but not limited to, a field emission cathode, a photo cathode, and an indirectly heated cathode. Preferably, the auxiliary cathode 30b may be a field emission cathode. The second electrons are directed to a second area 34b, which is different from the first area 34a, on the rotatable anode 26 for generating X-rays 46. The generated X-rays may also be referred to as unused X-rays. The focal spot on the rotatable anode 26, which is created by the auxiliary cathode 30b may not need to be well defined, as the generated X-rays are not used. Hence, the second area 34b may be configured to be large enough to carry high current. The generated X-rays 46 are configured to be directed to a direction different from that of the X-ray beam 44 such that the X-rays 46 do not enter the X-ray beam 44. For example, as illustrated in FIG. 3, the first area 34a and the second area 34b may be both tilted with respect to the centre axis 28, but have faces or fronts pointing in two different directions, e.g., in two opposite directions.

The electron current controlling device 40 is configured to adjust the auxiliary electron current 42b in response to a change of the primary electron current 42a such that a sum of the primary electron current and the auxiliary electron current remains constant during a multi-energy CT scan or other multi-energy X-ray exposure of an object.

In an example, as illustrated in FIG. 3, the electron current controlling device 40 may comprise an emission control grid 40a arranged between the auxiliary cathode 30b and the anode 26. The emission control grid 40a is configured to control the flow of the auxiliary electron current 42b between the auxiliary cathode 30b and the anode 26. For example, the intensity of the electron emission the primary cathode 30a emits may be changed by varying the temperature of the primary thermionic electron emitter. The emission control grid 40a may be charged such that the sum of the electron emission from both cathodes 30a, 30b is kept constant no matter what electron emission the primary cathode 30a generates. Typically, the emission control grid may be charged and discharged on a time scale of around 100 ms, when the primary cathode 30a comprises a thermionic emitter. This may enable a suitably fast response to a change of the primary electron current by changing the temperature of the primary emitter. In the exemplary rotatory anode X-ray tube illustrated in FIG. 1, the auxiliary cathode 30b is placed and charged with about the negative potential of the primary cathode 30a. In other words, the primary emitter 30a and the auxiliary emitter 30b may be connected in series. Thus, filaments or flat tungsten emitters are sharing the same heating current.

Optionally, when connected in series with the primary cathode 30b, the auxiliary cathode 30b may be configured to produce a sufficiently high auxiliary electron current at a lower heating power compared with a heating power required for the primary cathode to keep the sum of the primary electron current and the auxiliary electron current constant for the case that the primary cathode carries only a minimal primary electron current close to zero. In other words, when connected in series with the primary cathode 30a, the auxiliary cathode 30b may be required to be powerful enough. The auxiliary cathode 30b may need to produce high electron current even at low heating current, e.g., when dose modulation with the primary cathode is on, to deliver the full tube current, e.g., at minimal absolute grid voltage, for the case that the primary cathode 30a carries only a minimal current close to zero.

Optionally, the auxiliary cathode 30b may have a slew rate for rise and/or fall of the auxiliary electron current upon a change of the heating current, which is configured to be equal or higher than that of the primary cathode. The slew rate refers to the change of emission current per unit of time. The slew rate of emission current of the auxiliary cathode upon sudden change of the heating current, notably when heating is stopped, is higher at least for falling current than that of the primary cathode. The slew rate may be higher even at low emission current. The higher slew rate allows to synchronize the adjustment of the auxiliary electron current 42b with the change of the primary electron current 42a such that the sum of the primary electron current and the auxiliary electron current remains constant during the change of the heating current. To achieve a higher slew rate, the auxiliary cathode may be configured to have a higher heat conduction from a wire of the auxiliary cathode to a surrounding than that of the primary cathode. For example, the auxiliary cathode may be arranged on a thicker emitter holder such that the auxiliary cathode cools much faster than the primary cathode. Alternatively or additionally, the auxiliary cathode may be configured to have a higher heat radiation from a wire of the auxiliary cathode to a surrounding than that of the primary cathode. For example, the auxiliary cathode may have a thinner emitter wire such that it cools much faster than the primary cathode.

Alternatively to connection in series, the primary cathode 30a and the auxiliary cathode 30b may be connected in parallel (not shown), thus sharing the same heating voltage.

Both, connection in series and in parallel, may reduce the number of feed-throughs.

Optionally, the emission control grid 40a has a grid control voltage that is configured to sufficiently reduce the auxiliary electron current 42b such that the X-ray beam 44 is generated with a maximum X-ray intensity. In other words, the grid control voltage may be configured to allow to substantially, or totally, blank the auxiliary electron current 42b for the case that the rotary anode X-ray tube 12 has to produce the maximum of used X-ray intensity. As the auxiliary cathode 30b may not need to produce fine focal spots—this may be even unwanted to prevent anode melting, the filament of the auxiliary cathode 30b may be long and narrow. In this way, the cut-off grid voltage may be minimized.

Optionally, the X-ray tube 12 may comprise a further emission control grid (not shown) arranged between the primary cathode 30a and the anode 26. The further emission control grid is configured to control a shape of the first electrons to adjust a focal spot on the first area 34a on the rotatable anode 26. With the further emission control grid, the primary cathode 30a may be switched with a second analogue output or second digital output. A second analogue output may also be foreseen which may control the electron emission from the primary cathode 30a. It is noted, however, that the focal spot on the anode 26 is not overheated during such analogue current control. The emission from the auxiliary cathode has then to be controlled in such a way that the sum of both currents is kept constant.

Optionally, the further emission control grid may be configured as a focusing electrode or a set of focusing electrodes, e.g. a pair, in addition to its function as a current control grid, to keep the size of the focal spot constant when the tube voltage changes. The “grid” is typically a pair of electrodes at the same of slightly different negative bias voltages (different for focal spot deflection). This pair of electrodes may be used to keep the focal spot, the cross-sectional area of the electron beam at the target surface, constant even when the tube voltage changes, e.g. in dual energy mode of CT. Typically, the focal spot size changes when the bias grid voltage is constant and the tube voltage changes. This is not desired, as the X-ray projections at high tube voltage and low tube voltage should be exactly the same, except being acquired with different spectra. By keeping the focal spot size constant when the tube voltage changes, image artifacts or poor spectral performance of the X-ray system may be avoided. The grid control voltage, which controls the size of the focal spot, would be adapted accordingly. In addition, the auxiliary cathode may be equipped with a similar emission control grid. The grid control voltage of the auxiliary control grid would be adapted in sync with the changing primary control voltage to keep the total tube current constant even though the primary electron current would change with the changing tube voltage, the changing grid control voltage for focusing as well as with the changing heating current of the primary cathode. The total tube current, the sum of primary and auxiliary current, may also be controlled in a different way, other than keeping the total current constant.

In another example, instead of or in addition to the emission control grid 40a optionally with a further emission control grid, the electron current controlling device 40 may comprise at least one heating supply 48 configured to supply the primary and the auxiliary cathodes 30a, 30b with different heating powers such that the sum of the primary electron current and the auxiliary electron current remains constant.

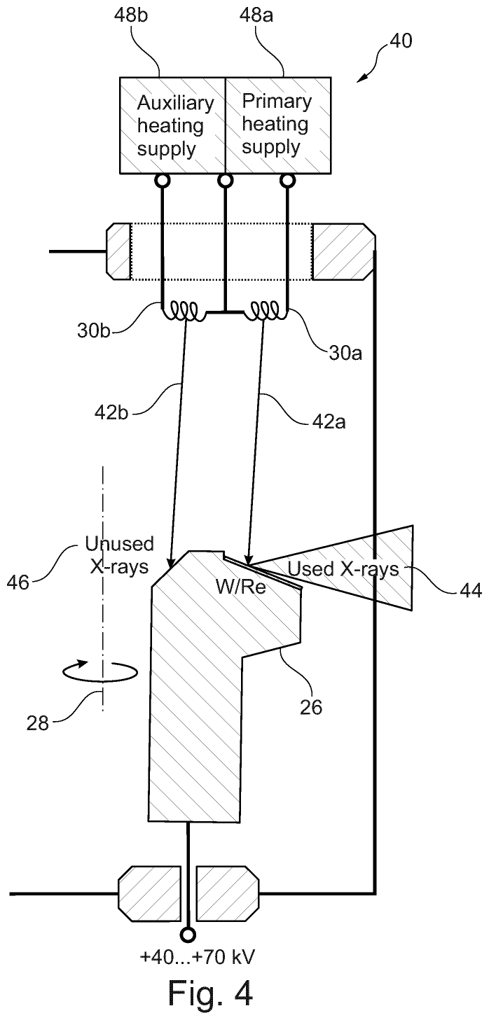

FIG. 4 shows a schematic central cut-through view of a rotary anode X-ray tube 12 according to some further embodiments of the present disclosure. In the exemplary rotatory anode X-ray tube illustrated in FIG. 4, at least one heating supply 48 is provided. The at least one heating supply 48 comprises a primary heating supply 48a associated with the primary cathode 30a. The primary cathode 30a comprises a wire filament or a flat sheet that emits electrons when heated. The temperature of the wire filament or flat emitter of the primary cathode 30a may be controlled by the primary heating supply 48a. As the heating current of the primary heating supply 48a is increased, the temperature of the wire filament of the primary cathode 30a is increased and the wire filament produces more electrons. The primary heating supply 48a thus controls the total number of X-rays produced by the primary cathode 30a. The at least one heating supply 48 further comprises an auxiliary heating supply 48b associated with the auxiliary cathode 30b. The auxiliary heating supply 48b is configured to change a heating current of the auxiliary cathode 30b to adjust the auxiliary electron current 42b in response to a change of the primary electron current 42a such that a sum of the primary electron current and the auxiliary electron current remains constant. In other words, the temperature of the auxiliary cathode is steered by the auxiliary heating supply 48b. The primary heating supply 48a and the auxiliary heating supply 48b may be controlled by a processing unit, which changes the heating current of the auxiliary heating supply 48b based on the primary electron current 42a generated by the primary cathode 30a. Thus, the down-ramp of the tube voltage for dual energy scanning is kept constant even though the X-ray output of the tube changes e.g., for dose modulation.

In the exemplary rotatory anode X-ray tube illustrated in FIG. 4, the auxiliary cathode 30b is placed and charged with about the negative potential of the primary cathode 30a. In other words, the primary cathode 30a and the auxiliary cathode 30b may be connected in series, thus sharing the same heating current. When two cathodes 30a, 30b are connected in series, the auxiliary cathode may be powerful enough to produce high electron current even at low heating current, e.g., when dose modulation with the primary cathode is on, to deliver the full tube current, e.g., at minimal absolute grid voltage, for the case that the primary cathode carries only a minimal current close to zero. Optionally, the auxiliary cathode 30b may be configured to produce a sufficiently high auxiliary electron current at a lower heating power compared with a heating power required for the primary cathode to keep the sum of the primary electron current and the auxiliary electron current constant for the case that the primary cathode carries only a minimal primary electron current close to zero. Optionally, the auxiliary cathode 30b may have a slew rate for rise and/or fall of the auxiliary electron current upon a change of the heating current, which is configured to be equal or higher than that of the primary cathode. To achieve a higher slew rate, the auxiliary cathode may be configured to have a higher heat conduction from a wire of the auxiliary cathode to a surrounding than that of the primary cathode. Alternatively or additionally, the auxiliary cathode may be configured to have a higher heat radiation from a wire of the auxiliary cathode to a surrounding than that of the primary cathode.

Alternatively, the primary cathode 30a and the auxiliary cathode 30b may be connected in parallel (not shown), thus sharing the same heating voltage.

In a further example (not shown), instead of using two heating supplies, i.e. the primary heating supply and the auxiliary heating supply, an AC heating circuit with a variable frequency may be provided. The AC heating circuit is configured to supply the primary and the auxiliary cathodes with different heating powers using at least one of an inductor and a capacitor. The distribution of the current then takes place in the tube with inductors and/or capacitors. Since it is possible to set the frequency almost arbitrarily high, a few strategically distributed additional turns in the coils of the primary cathode may be sufficient. Such a variable frequency heating circuit may not be much more expensive than a conventional one.

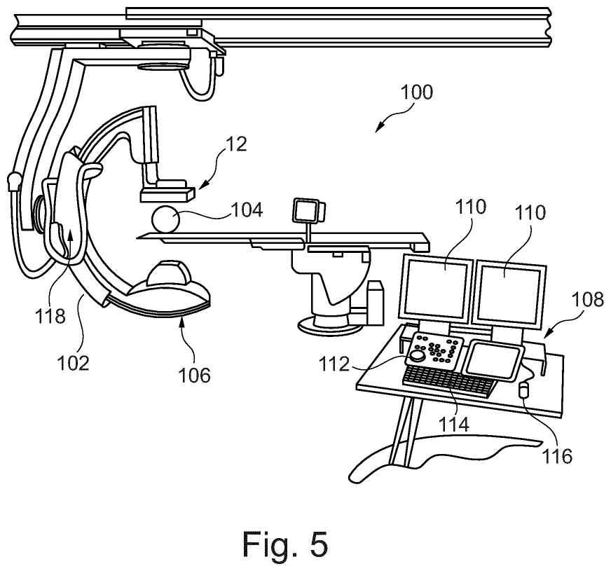

FIG. 5 shows an X-ray imaging system 100 according to some embodiments of the present disclosure in a C-arm X-ray imaging suite. Other examples of the X-ray imaging system may include, but not limited to, a CT imaging system or a fluoroscopy system.

The C-arm imaging system 100 has a support arrangement 102 which may translate through azimuth and elevation axes around the object of interest 104. For example, the C-arm X-ray imaging system 100 may be supported from the ceiling of an X-ray facility. The support arrangement holds a rotary anode X-ray source 12 as described above and below, and an X-ray detector 106.

The C-arm imaging system (or CT imaging system) is optionally provided with motion sensors (for example, rotary encoders in the C-arm or CT gantry axes). This enables the feedback of motion information to the X-ray imaging system state detector.

Alternatively, or in combination, the X-ray imaging system state detector is configured to receive a list of motion commands representing a pre-planned imaging protocol.

The C-arm X-ray imaging system is controlled, for example, from a control console 108, comprising, for example, display screens 110, computer apparatus 112 optionally functioning as a stator control system, controllable via a keyboard 114 and a mouse 116.

The C-arm 118 is configured to translate around the object of interest 104, not simply in a flat rotational sense (in the sense of a CT scanner), but also by tilting.

In operation, an object of interest 104 is placed in between the detector 106 and the X-ray source 12 of a C-arm imaging system 100. The C-arm may rotate about the patient for acquisition of an image data set which is then used for 3D image reconstruction. An X-ray imaging system scanning protocol is initiated using the control console 114.

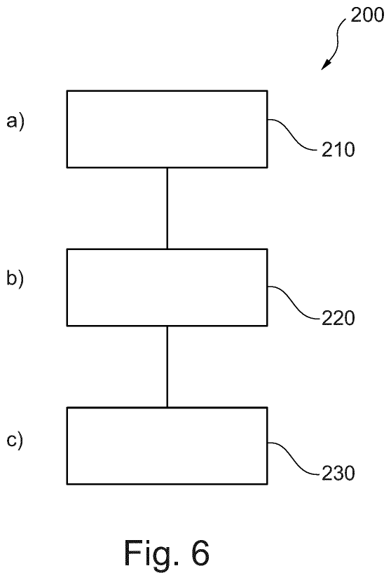

FIG. 6 shows a flow diagram of a method 200 of X-ray tube control according to some embodiments of the present disclosure. In step 210, i.e. step a), first electrons are emitted by a primary cathode establishing a flow of primary electron current. The first electrons are focused on a first area on a rotatable anode of the X-ray tube for generating an X-ray beam. The primary cathode may comprise at least one of a field emission cathode, a photo cathode, and an indirectly heated cathode.

In step 220, i.e. step b), second electrons are emitted by an auxiliary cathode establishing a flow of auxiliary electron current. The second electrons are directed to a second area, which is different from the first area, on the rotatable anode for generating X-rays. The generated X-rays are configured to be directed to a direction different from that of the X-ray beam such that the X-rays do not enter the X-ray beam. In an example, the primary cathode and the auxiliary cathode are connected in series or in parallel. When connected in series with the primary cathode, the auxiliary cathode may be configured to produce a sufficiently high auxiliary electron current at a lower heating power compared with a heating power required for the primary cathode to keep the sum of the primary electron current and the auxiliary electron current constant for the case that the primary cathode carries only a minimal primary electron current close to zero. The auxiliary cathode is configured to have a slew rate for rise and/or fall of the auxiliary electron current upon a change of the heating current, which is configured to be equal or higher than that of the primary cathode. To achieve a higher slew rate, the auxiliary cathode may be configured to have a higher heat conduction from a wire of the auxiliary cathode to a surrounding than that of the primary cathode. Alternatively or additionally, the auxiliary cathode may be configured to have a higher heat radiation from a wire of the auxiliary cathode to a surrounding than that of the primary cathode. The auxiliary cathode may comprise a field emission cathode.

In step 230, i.e. step c), the auxiliary electron current is adjusted by an electron current controlling device in response to a change of the primary electron current such that a sum of the primary electron current and the auxiliary electron current remains constant.

In an example, the electron current controlling device may comprise an emission control grid arranged between the auxiliary cathode and the anode. The emission control grid may be configured to control the flow of the auxiliary electron current between the auxiliary cathode and the anode. Optionally, the emission control grid may have a grid control voltage that is configured to sufficiently reduce the auxiliary electron current such that the X-ray beam is generated with a maximum X-ray intensity. Optionally, the X-ray tube may comprise a further emission control grid arranged between the primary cathode and the anode. The further emission control grid is configured to control a shape of the first electrons to adjust a focal spot on the first area on the rotatable anode.

In another example, the electron current controlling device may comprise at least one heating supply configured to supply the primary and the auxiliary cathodes with different heating powers such that the sum of the primary electron current and the auxiliary electron current remains constant. Optionally, the at least one heating supply may comprise an alternating current (AC) heating circuit with a variable frequency. The AC heating circuit is configured to supply the primary and the auxiliary cathodes with different heating powers using at least one of an inductor and a capacitor. Alternatively, the at least one heating supply may comprise a primary heating supply associated with the primary cathode and an auxiliary heating supply associated with the auxiliary cathode. The auxiliary heating supply may be configured to change a heating current of the auxiliary cathode to adjust the auxiliary electron current in response to a change of the primary electron current such that a sum of the primary electron current and the auxiliary electron current remains constant.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An X-ray tube for generating an X-ray beam, comprising:
a primary cathode;
an auxiliary cathode;
a rotatable anode; and
an electron current controller;
wherein the primary cathode is configured to emit first electrons establishing a flow of primary electron current, the first electrons being focused on a first area on the rotatable anode for generating the X-ray beam;
wherein the auxiliary cathode is configured to emit second electrons establishing a flow of auxiliary electron current, the second electrons being directed to a second area, which is different from the first area, on the rotatable anode for generating X-rays, wherein the generated X-rays are configured to be directed to a direction different from that of the X-ray beam, such that the X-rays do not enter the X-ray beam; and
wherein the electron current controller is configured to adjust the auxiliary electron current in response to a change of the primary electron current, such that a sum of the primary electron current and the auxiliary electron current remains constant.

2. The X-ray tube according to claim 1, wherein the electron current controller comprises an emission control grid arranged between the auxiliary cathode and the anode; and wherein the emission control grid is configured to control the flow of the auxiliary electron current between the auxiliary cathode and the anode.

3. The X-ray tube according to claim 2, wherein the emission control grid has a grid control voltage that is configured to sufficiently reduce the auxiliary electron current, such that the X-ray beam is generated with a maximum X-ray intensity.

4. The X-ray tube according to claim 1, wherein the electron current controller comprises
at least one heating supply configured to supply the primary and the auxiliary cathodes with different heating powers, such that the sum of the primary electron current and the auxiliary electron current remains constant.

5. The X-ray tube according to claim 4, wherein the at least one heating supply comprises
an alternating current AC heating circuit with a variable frequency; wherein the AC heating circuit is configured to supply the primary and the auxiliary cathodes with different heating powers using at least one of a inductor and a capacitor.

6. The X-ray tube according to claim 4, wherein the at least one heating supply comprises:
a primary heating supply associated with the primary cathode; and
an auxiliary heating supply associated with the auxiliary cathode, wherein the auxiliary heating supply is configured to change a heating current of the auxiliary cathode to adjust the auxiliary electron current in response to a change of the primary electron current, such that a sum of the primary electron current and the auxiliary electron current remains constant.

7. The X-ray tube according to claim 1, further comprising an emission control grid arranged between the primary cathode and the anode, and wherein the emission control grid is configured to control a shape of the first electrons to adjust a focal spot on the first area on the rotatable anode.

8. The X-ray tube according to claim 7, wherein the emission control grid is configured as a focusing electrode or a set of focusing electrodes to keep a size of the focal spot constant when the tube voltage changes.

9. The X-ray tube according to claim 1, wherein the primary cathode and the auxiliary cathode are connected in series or in parallel.

10. The X-ray tube according to claim 9, wherein, when connected in series with the primary cathode, the auxiliary cathode is configured to produce a sufficiently high auxiliary electron current at a lower heating power compared with a heating power required for the primary cathode to keep the sum of the primary electron current and the auxiliary electron current constant for the case that the primary cathode carries only a minimal primary electron current close to zero.

11. The X-ray tube according to claim 10, wherein the auxiliary cathode is configured to have a slew rate for rise and/or fall of the auxiliary electron current upon a change of the heating current, which is configured to be equal or higher than that of the primary cathode.

12. The X-ray tube according to claim 11, wherein the auxiliary cathode is configured to have:
a higher heat conduction from a wire of the auxiliary cathode to a surrounding than that of the primary cathode; and/or
a higher heat radiation from a wire of the auxiliary cathode to a surrounding than that of the primary cathode.

13. The X-ray tube according to claim 1, wherein the auxiliary cathode comprises a field emission cathode.

14. An X-ray imaging system, comprising:
an X-ray tube comprising:
a primary cathode;
an auxiliary cathode;
a rotatable anode; and
an electron current controller;
wherein the primary cathode is configured to emit first electrons establishing a flow of primary electron current, the first electrons being focused on a first area on the rotatable anode for generating the X-ray beam;
wherein the auxiliary cathode is configured to emit second electrons establishing a flow of auxiliary electron current, the second electrons being directed to a second area, which is different from the first area, on the rotatable anode for generating X-rays, wherein the generated X-rays are configured to be directed to a direction different from that of the X-ray beam, such that the X-rays do not enter the X-ray beam; and
wherein the electron current controller is configured to adjust the auxiliary electron current in response to a change of the primary electron current, such that a sum of the primary electron current and the auxiliary electron current remains constant; and
an X-ray detector arranged to be opposite to the X-ray tube, wherein the X-ray tube is configured to generate an X-ray beam towards an object of interest; and wherein the X-ray detector is configured to detect attenuated X-rays passing through the object of interest.

15. A method of controlling an X-ray tube control, comprising:
emitting, by a primary cathode of an X-ray tube claim 1, first electrons establishing a flow of primary electron current, the first electrons being focused on a first area on a rotatable anode of the X-ray tube for generating an X-ray beam;
emitting, by an auxiliary cathode of the X-ray tube, second electrons establishing a flow of auxiliary electron current, the second electrons being directed to a second area, which is different from the first area, on the rotatable anode for generating X-rays, wherein the generated X-rays are configured to be directed to a direction different from that of the X-ray beam such that the X-rays do not enter the X-ray beam; and
adjusting, by an electron current controller, the auxiliary electron current in response to a change of the primary electron current such that a sum of the primary electron current and the auxiliary electron current remains constant.
